(19) United States
(12) Patent Application Publication
(10) Pub. No.: US 2012/0221985 A1
(43) Pub. Date: Aug. 30, 2012

(54) METHOD AND SYSTEM FOR DESIGN OF A SURFACE TO BE MANUFACTURED USING CHARGED PARTICLE BEAM LITHOGRAPHY

(75) Inventor: Akira Fujimura, Saratoga, CA (US)

(73) Assignee: D2S, INC., San Jose, CA (US)

(21) Appl. No.: 13/037,263

(22) Filed: Feb. 28, 2011

(51) Int. Cl. G06F 17/50

(52) U.S. Cl. 716/55

(57) ABSTRACT

A method and system for fracturing or mask data preparation are disclosed which can reduce the critical dimension variation of patterns formed on a resist-coated surface using particle beam lithography by providing a higher peak dosage near the perimeter of the patterns than in the interiors of the patterns.

### RELATED APPLICATIONS

This application: 1) is related to Fujimura, U.S. patent application Ser. No. ______, entitled “Method and System For Design Of Enhanced Accuracy Patterns For Charged Particle Beam Lithography,” (Attorney Docket No. D2SiP033a) filed on even date herewith; and 2) is related to Fujimura, U.S. patent application Ser. No. ______, entitled “Method and System For Design Of Enhanced Edge Slope Patterns For Charged Particle Beam Lithography,” (Attorney Docket No. D2SiP033b) filed on even date herewith; both of which are hereby incorporated by reference for all purposes.

### BACKGROUND OF THE DISCLOSURE

The present disclosure is related to lithography, and more particularly to the design and manufacture of a surface which may be a reticle, a wafer, or any other surface, using charged particle beam lithography.

In the production or manufacturing of semiconductor devices, such as integrated circuits, optical lithography may be used to fabricate the semiconductor devices. Optical lithography is a printing process in which a lithographic mask or photomask manufactured from a reticle is used to transfer patterns to a substrate such as a semiconductor or silicon wafer to create the integrated circuit (I.C.). Other substrates could include flat panel displays or even other reticles. Also, extreme ultraviolet (EUV) or X-ray lithography are considered types of optical lithography. The reticle or multiple reticles may contain a circuit pattern corresponding to an individual layer of the integrated circuit, and this pattern can be imaged onto a certain area on the substrate that has been coated with a layer of radiation-sensitive material known as photoresist or resist. Once the patterned layer is transferred the layer may undergo various other processes such as etching, ion-implantation (doping), metallization, oxidation, and polishing. These processes are employed to finish an individual layer in the substrate. If several layers are required, then the whole process or variations thereof will be repeated for each new layer. Eventually, a combination of multiples of devices or integrated circuits will be present on the substrate. These integrated circuits may then be separated from one another by dicing or sawing and then may be mounted into individual packages. In the more general case, the patterns on the substrate may be used to define artifacts such as display pixels, holograms, or magnetic recording heads.

In the production or manufacturing of semiconductor devices, such as integrated circuits, maskless direct write may also be used to fabricate the semiconductor devices. Maskless direct write is a printing process in which charged particle beam lithography is used to transfer patterns to a substrate such as a semiconductor or silicon wafer to create the integrated circuit. Other substrates could include flat panel displays, imprint masks for nano-imprinting, or even reticles. Desired patterns of a layer are written directly on the surface, which in this case is also the substrate. Once the patterned layer is transferred the layer may undergo various other processes such as etching, ion-implantation (doping), metallization, oxidation, and polishing. These processes are employed to finish an individual layer in the substrate. If several layers are required, then the whole process or variations thereof will be repeated for each new layer. Some of the layers may be written using optical lithography while others may be written using maskless direct write to fabricate the same substrate. Also, some patterns of a given layer may be written using optical lithography, and other patterns written using maskless direct write. Eventually, a combination of multiples of devices or integrated circuits will be present on the substrate. These integrated circuits are then separated from one another by dicing or sawing and then mounted into individual packages. In the more general case, the patterns on the surface may be used to define artifacts such as display pixels, holograms, or magnetic recording heads.

Two common types of charged particle beam lithography are variable shaped beam (VSB) and character projection (CP). These are both sub-categories of shaped beam charged particle beam lithography, in which a precise electron beam is shaped and steered so as to expose a resist-coated surface, such as the surface of a wafer or the surface of a reticle. In VSB, these shapes are simple shapes, usually limited to rectangles of certain minimum and maximum sizes and with sides which are parallel to the axes of a Cartesian coordinate plane (i.e. of “manhattan” orientation), and 45 degree right triangles (i.e. triangles with their three internal angles being 45 degrees, 45 degrees, and 90 degrees) of certain minimum and maximum sizes. At predetermined locations, doses of electrons are shot into the resist with these simple shapes. The total writing time for this type of system increases with the number of shots. In character projection (CP), there is a stencil in the system that has in it a variety of apertures or characters which may be complex shapes such as rectilinear, arbitrary-angled linear, circular, nearly circular, annular, nearly annular, oval, nearly oval, partially circular, partially nearly circular, partially annular, partially nearly annular, partially nearly oval, or arbitrary curvilinear shapes, and which may be a connected set of complex shapes or a group of disjointed sets of a connected set of complex shapes. An electron beam can be shot through a character on the stencil to efficiently produce more complex patterns on the reticle. In theory, such a system can be faster than a VSB system because it can shoot more complex shapes with each time-consuming shot. Thus, an E-shaped pattern shot with a VSB system takes four shots, but the same E-shaped pattern can be shot with one shot with a character projection system. Note that VSB systems can be thought of as a special (simple) case of character projection, where the characters are just simple characters, usually rectangles or 45-45-90 degree triangles. It is also possible to partially expose a character. This can be done by, for instance, blocking part of the particle beam. For example, the E-shaped pattern described above can be partially exposed as an F-shaped pattern or an I-shaped pattern, where different parts of the beam are cut off by an aperture. This is the same mechanism as how various sized rectangles can be shot using VSB. In this disclosure, partial projection is used to mean both character projection and VSB projection.

As indicated, in optical lithography the lithographic mask or reticle comprises geometric patterns corresponding to the circuit components to be integrated onto a substrate. The patterns used to manufacture the reticle may be generated utilizing computer-aided design (CAD) software or programs. In designing the patterns the CAD program may follow a set of pre-determined design rules in order to create the reticle. These rules are set by processing, design, and end-use limitations. An example of an end-use limitation is defining the geometry of a transistor in a way in which it cannot sufficiently operate at the required supply voltage. In particular, design rules can define the space tolerance between circuit devices or interconnect lines. The design rules are, for example, used to ensure that the circuit devices or lines do not interact with one another in an undesirable manner. For example, the design rules are used so that lines do not get too close to each other in a way that may cause a short circuit. The design rule limitations reflect, among other things, the smallest dimensions that can be reliably fabricated. When referring to these small dimensions, one usually introduces the concept of a critical dimension. These are, for instance, defined as the smallest width of a line or the smallest space between two lines, those dimensions requiring exquisite control.

One goal in integrated circuit fabrication by optical lithography is to reproduce the original circuit design on the substrate by use of the reticle. Integrated circuit fabricators are always attempting to use the semiconductor wafer real estate as efficiently as possible. Engineers keep shrinking the size of the circuits to allow the integrated circuits to contain more circuit elements and to use less power. As the size of an integrated circuit critical dimension is reduced and its circuit density increases, the critical dimension of the circuit pattern or physical design approaches the resolution limit of the optical exposure tool used in optical lithography. As the critical dimensions of the circuit pattern become smaller and approach the resolution value of the exposure tool, the accurate transcription of the physical design to the actual circuit pattern developed on the resist layer becomes difficult. To further the use of optical lithography to transfer patterns having features that are smaller than the light wavelength used in the optical lithography process, a process known as optical proximity correction (OPC) has been developed. OPC alters the physical design to compensate for distortions caused by effects such as optical diffraction and the optical interaction of features with proximate features. OPC includes all resolution enhancement technologies performed with a reticle.

OPC may add sub-resolution lithographic features to mask patterns to reduce differences between the original physical design pattern, that is, the design, and the final transferred circuit pattern on the substrate. The sub-resolution lithographic features interact with the original patterns in the physical design and with each other and compensate for proximity effects to improve the final transferred circuit pattern. One feature that is used to improve the transfer of the pattern is a sub-resolution assist feature (SRAF). Another feature that is added to improve pattern transference is referred to as “serifs”. Serifs are small features that can be positioned on a corner of a pattern to sharpen the corner in the final transferred image. It is often the case that the precision demanded of the surface manufacturing process for SRAFs are less than those for patterns that are intended to print on the substrate, often referred to as main features. Serifs are a part of a main feature. As the limits of optical lithography are being extended far into the sub-wavelength regime, the OPC features must be made more and more complex in order to compensate for even more subtle interactions and effects. As imaging systems are pushed closer to their limits, the ability to produce reticles with sufficiently fine OPC features becomes critical. Although adding serifs or other OPC features to a mask pattern is advantageous, it also substantially increases the total feature count in the mask pattern. For example, adding a serif to each of the corners of a square using conventional techniques adds eight more rectangles to a mask or reticle pattern. Adding OPC features is a very laborious task, requires costly computation time, and results in more expensive reticles. Not only are OPC patterns complex, but since optical proximity effects are long range compared to minimum line and space dimensions, the correct OPC patterns in a given location depend significantly on what other geometry is in the neighborhood. Thus, for instance, a line end will have different size serifs depending on what is near it on the reticle. This is even though the objective might be to produce exactly the same shape on the wafer. These slight but critical variations are important and have prevented others from being able to form reticle patterns. It is conventional to discuss the OPC-decorated patterns to be written on a reticle in terms of main features, that is features that reflect the design before OPC decoration, and OPC features, where OPC features might include serifs, jogs, and SRAF. To quantify what is meant by slight variations, a typical slight variation in OPC decoration from neighborhood to neighborhood might be 5% to 80% of a main feature size. Note that for clarity, variations in the design of the OPC are what is being referenced. Manufacturing variations, such as line-edge roughness and corner rounding, will also be present in the actual surface patterns. When these OPC variations produce substantially the same patterns on the wafer, what is meant is that the geometry on the wafer is targeted to be the same within a specified error, which depends on the details of the function that that geometry is designed to perform, e.g., a transistor or a wire. Nevertheless, typical specifications are in the 2%-50% of a main feature range. There are numerous manufacturing factors that also cause variations, but the OPC component of that overall error is often in the range listed. OPC shapes such as sub-resolution assist features are subject to various design rules, such as a rule based on the size of the smallest feature that can be transferred to the wafer using optical lithography. Other design rules may come from the mask manufacturing process or, if a character projection charged particle beam writing system is used to form the pattern on a reticle, from the stencil manufacturing process. It should also be noted that the accuracy requirement of the SRAF features on the mask may be lower than the accuracy requirements for the main features on the mask.

There are a number of technologies used for forming patterns on a reticle, including using optical lithography or charged particle beam lithography. The most commonly used system is the variable shaped beam (VSB), where, as described above, doses of electrons with simple shapes such as manhattan rectangles and 45-degree right triangles expose a resist-coated reticle surface. In conventional mask writing, the doses or shots of electrons are conventionally designed to avoid overlap wherever possible, so as to greatly simplify calculation of how the resist on the reticle will register the pattern. Similarly, the set of shots is designed so as to completely cover the pattern area that is to be formed on the reticle.

Reticle writing for the most advanced technology nodes typically involves multiple passes of charged particle beam writing, a process called multi-pass exposure, whereby the given shape on the reticle is written and overwritten. Typically, two to four passes are used to write a reticle to average out precision errors in the charged particle beam writer, allowing the creation of more accurate photomasks. Also typically, the list of shots, including the dosages, is the same for every pass. In one variation of multi-pass exposure, the lists of shots may vary among exposure passes, but the union of the shots in any exposure pass covers the same area. Multi-pass writing can reduce over-heating of the resist coating the surface. Multi-pass writing also averages out random errors of the charged particle beam writer. Multi-pass writing using different shot lists for different exposure passes can also reduce the effects of certain systemic errors in the writing process.

There are numerous undesirable short-range and long-range effects associated with charged particle beam exposure. The long-range effects such as back scatter and fogging are a function of the sum of dosages of all shots in an area of the pattern, called area dosage, or of the total dosage of all shots written to the surface. It would therefore be desirable to be able to reduce the total dosage received by the surface of the substrate or reticle, while still forming the desired pattern on the resist within a predetermined tolerance. Additionally, it would be advantageous to simultaneously reduce time required to expose the pattern on the surface, so as to reduce the cost of manufacturing the surface, such as a reticle or wafer.

### SUMMARY OF THE DISCLOSURE

A method and system for fracturing or mask data preparation are disclosed in which a set of charged particle beam shots produce a higher peak dosage near the perimeter of a desired pattern than in the interior of the desired pattern. The techniques of this disclosure advantageously reduce critical dimension variation of patterns in semiconductor manufacturing while preventing unnecessary increases in total dosage. In one embodiment, gaps may be left between shot outlines, where the gaps are sufficiently small that no gap will be formed on the surface. In other embodiments, overlapping shots may be used. Yet other embodiments include the use of dragged shots. The method may be used with variable shaped beam (VSB) shots, character projection (CP) shots, or a combination of VSB and CP shots.

### BRIEF DESCRIPTION OF THE DRAWINGS

FIG. 1 illustrates an example of a character projection charged particle beam system;

FIG. 2A illustrates an example of a single charged particle beam shot and a cross-sectional dosage graph of the shot;

FIG. 2B illustrates an example of a pair of proximate shots and a cross-sectional dosage graph of the shot pair;

FIG. 2C illustrates an example of a pattern formed on a resist-coated surface from the pair of FIG. 2B shots;

FIG. 3A illustrates an example of a polygonal pattern;

FIG. 3B illustrates an example of a conventional fracturing of the polygonal pattern of FIG. 3A;

FIG. 3C illustrates an example of an alternate fracturing of the polygonal pattern of FIG. 3A;

FIG. 4A illustrates an example of a shot outline from a rectangular shot;

FIG. 4B illustrates an example of a longitudinal dosage curve for the shot of FIG. 4A using a normal shot dosage;

FIG. 4C illustrates an example of a longitudinal dosage curve similar to FIG. 4B, with long-range effects included;

FIG. 4D illustrates an example of a longitudinal dosage curve for the shot of FIG. 4A using a higher than normal shot dosage;

FIG. 4E illustrates an example of a longitudinal dosage curve similar to FIG. 4C, with long-range effects included;

FIG. 4F illustrates an example of a longitudinal dosage curve similar to FIG. 4E, but with a higher background dosage level;

FIG. 5A illustrates an example of a circular pattern to be formed on a surface;

FIG. 5B illustrates an example of outlines of nine shots which can form the pattern of FIG. 5A;

FIG. 6A illustrates an example of a pattern comprising two squares, before OPC;

FIG. 6B illustrates an example of a curvilinear pattern which may be produced by OPC processing of the pattern of FIG. 6A;

FIG. 6C illustrates an example of how the pattern of FIG. 6B may be formed using dragged circular CP shots and VSB shots;

FIG. 6D illustrates another example of how the pattern of FIG. 6B may be formed using dragged circular CP shots and VSB shots;

FIG. 7 illustrates a conceptual flow diagram of how to prepare a surface, such as a reticle, for use in fabricating a substrate such as an integrated circuit on a silicon wafer using optical lithography; and

FIG. 8 illustrates a conceptual flow diagram of how to prepare a surface for use in fabricating a substrate such as an integrated circuit on a silicon wafer.

### DETAILED DESCRIPTION OF THE EMBODIMENTS

The present disclosure describes a method for fracturing patterns into shots for a charged particle beam writer, where a higher peak dosage is provided to pattern areas near the pattern perimeters than to interior areas of the patterns. This method may reduce critical dimension (CD) variation of the patterns subsequently generated on a surface, and may also reduce exposure time.

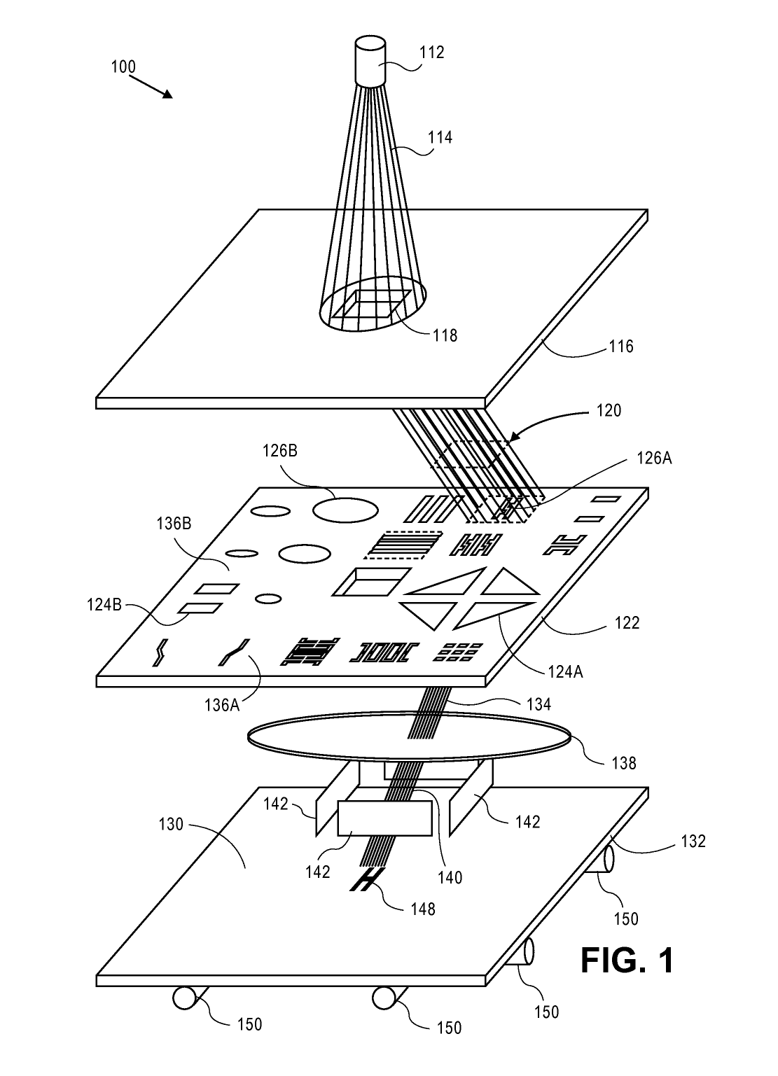

Referring now to the drawings, wherein like numbers refer to like items, FIG. 1 illustrates an embodiment of a conventional lithography system 100, such as a charged particle beam writer system, in this case an electron beam writer system, that employs character projection to manufacture a surface 130. The electron beam writer system 100 has an electron beam source 112 that projects an electron beam 114 toward an aperture plate 116. The plate 116 has an aperture 118 formed therein which allows the electron beam 114 to pass. Once the electron beam 114 passes through the aperture 118 it is directed or deflected by a system of lenses (not shown) as electron beam 120 toward another rectangular aperture plate or stencil mask 122. The stencil 122 has formed therein a number of openings or apertures 124 that define various types of characters 126, which may be complex characters. Each character 126 formed in the stencil 122 may be used to form a pattern 148 on a surface 130 of a substrate 132, such as a silicon wafer, a reticle or other substrate. In partial exposure, partial projection, partial character projection, or variable character projection, electron beam 120 may be positioned so as to strike or illuminate only a portion of one of the characters 126, thereby forming a pattern 148 that is a subset of character 126. For each character 126 that is smaller than the size of the electron beam 120 defined by aperture 118, a blanking area 136, containing no aperture, is designed to be adjacent to the character 126, so as to prevent the electron beam 120 from illuminating an unwanted character on stencil 122. An electron beam 134 emerges from one of the characters 126 and passes through an electromagnetic or electrostatic reduction lens 138 which reduces the size of the pattern from the character 126. In commonly available charged particle beam writer systems, the reduction factor is between 10 and 60. The reduced electron beam 140 emerges from the reduction lens 138, and is directed by a series of deflectors 142 onto the surface 130 as the pattern 148, which is depicted as being in the shape of the letter “H” corresponding to character 126A. The pattern 148 is reduced in size compared to the character 126A because of the reduction lens 138. The pattern 148 is drawn by using one shot of the electron beam system 100. This reduces the overall writing time to complete the pattern 148 as compared to using a variable shape beam (VSB) projection system or method. Although one aperture 118 is shown being formed in the plate 116, it is possible that there may be more than one aperture in the plate 116. Although two plates 116 and 122 are shown in this example, there may be only one plate or more than two plates, each plate comprising one or more apertures.

In conventional charged particle beam writer systems the reduction lens 138 is calibrated to provide a fixed reduction factor. The reduction lens 138 and/or the deflectors 142 also focus the beam on the plane of the surface 130. The size of the surface 130 may be significantly larger than the maximum beam deflection capability of the deflection plates 142. Because of this, patterns are normally written on the surface in a series of stripes. Each stripe contains a plurality of sub-fields, where a sub-field is within the beam deflection capability of the deflection plates 142. The electron beam writer system 100 contains a positioning mechanism 150 to allow positioning the substrate 132 for each of the stripes and sub-fields. In one variation of the conventional charged particle beam writer system, the substrate 132 is held stationary while a sub-field is exposed, after which the positioning mechanism 150 moves the substrate 132 to the next sub-field position. In another variation of the conventional charged particle beam writer system, the substrate 132 moves continuously during the writing process. In this variation involving continuous movement, in addition to deflection plates 142, there may be another set of deflection plates (not shown) to move the beam at the same speed and direction as the substrate 132 is moved.

The minimum size pattern that can be projected with reasonable accuracy onto a surface 130 is limited by a variety of short-range physical effects associated with the electron beam writer system 100 and with the surface 130, which normally comprises a resist coating on the substrate 132. These effects include forward scattering, Coulomb effect, and resist diffusion. Beam blur is a term used to include all of these short-range effects. The most modern electron beam writer systems can achieve an effective beam blur in the range of 20 nm to 30 nm. Forward scattering may constitute one quarter to one half of the total beam blur. Modern electron beam writer systems contain numerous mechanisms to reduce each of the constituent pieces of beam blur to a minimum. Some electron beam writer systems may allow the beam blur to be varied during the writing process, from the minimum value available on an electron beam writing system to one or more larger values.

The shot dosage of a charged particle beam writer such as an electron beam writer system is a function of the intensity of the beam source 112 and the exposure time for each shot. Typically the beam intensity remains fixed, and the exposure time is varied to obtain variable shot dosages. The exposure time may be varied to compensate for various long-range effects such as back scatter and fogging in a process called proximity effect correction (PEC). Electron beam writer systems usually allow setting an overall dosage, called a base dosage, that affects all shots in an exposure pass. Some electron beam writer systems perform dosage compensation calculations within the electron beam writer system itself, and do not allow the dosage of each shot to be assigned individually as part of the input shot list, the input shots therefore having unassigned shot dosages. In such electron beam writer systems all shots have the base dosage, before proximity effects correction. Other electron beam writer systems do allow dosage assignment on a shot-by-shot basis. In electron beam writer systems that allow shot-by-shot dosage assignment, the number of available dosage levels may be 64 to 4096 or more, or there may be a relatively few available dosage levels, such as 3 to 8 levels. Some embodiments of the current invention are targeted for use with charged particle beam writing systems which either do not allow dosage assignment on a shot-by-shot basis, or which allow assignment of one of a relatively few dosage levels.

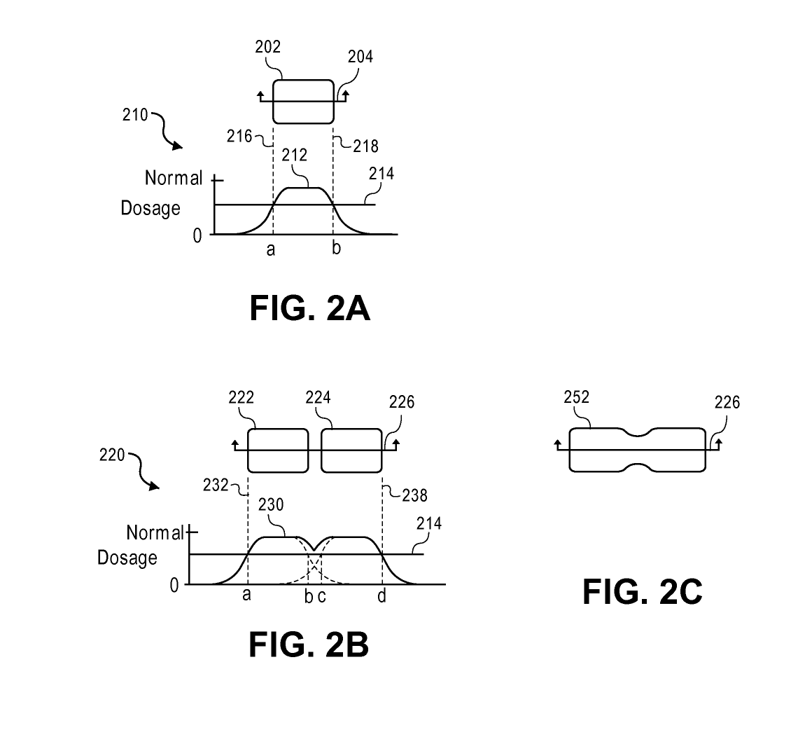

FIGS. 2A-B illustrate how energy is registered on a resist-coated surface from one or more charged particle beam shots. In FIG. 2A rectangular pattern 202 illustrates a shot outline, which is a pattern that will be produced on a resist-coated surface from a shot which is not proximate to other shots. In dosage graph 210, dosage curve 212 illustrates the cross-sectional dosage along a line 204 through shot outline 202. Line 214 denotes the resist threshold, which is the dosage above which the resist will register a pattern. As can be seen from dosage graph 210, dosage curve 212 is above the resist threshold between the X-coordinates “a” and “b”. Coordinate “a” corresponds to dashed line 216, which denotes the left-most extent of the shot outline 202. Similarly, coordinate “b” corresponds to dashed line 218, which denotes the right-most extent of the shot outline 202. The shot dosage for the shot in the example of FIG. 2A is a normal dosage, as marked on dosage graph 210. In conventional mask writing methodology, the normal dosage is set so that a relatively large rectangular shot will register a pattern of the desired size on the resist-coated surface, in the absence of long-range effects. The normal dosage therefore depends on the value of the resist threshold 214.

FIG. 2B illustrates the shot outlines of two particle beam shots, and the corresponding dosage curve. Shot outline 222 and shot outline 224 result from two proximate particle beam shots. In dosage graph 220, dosage curve 230 illustrates the dosage along the line 226 through shot outlines 222 and 224. As shown in dosage curve 230, the dosage registered by the resist along line 226 is the combination, such as the sum, of the dosages from two particle beam shots, represented by shot outline 222 and shot outline 224. As can be seen, dosage curve 230 is above the threshold 214 from X-coordinate “a” to X-coordinate “d”. This indicates that the resist will register the two shots as a single shape, extending from coordinate “a” to coordinate “d”. FIG. 2C illustrates a pattern 252 that the two shots from the example of FIG. 2B may form. The variable width of pattern 252 is the result of the gap between shot outline 222 and shot outline 224, and illustrates that a gap between the shots 222 and 226 causes dosage to drop below threshold near the corners of the shot outlines closest to the gap.

When using conventional non-overlapping shots using a single exposure pass, conventionally all shots are assigned a normal dosage before PEC dosage adjustment. A charged particle beam writer which does not support shot-by-shot dosage assignment can therefore be used by setting the base dosage to a normal dosage. If multiple exposure passes are used with such a charged particle beam writer, the base dosage is conventionally set according to the following equation:

base dosage=normal dosage/# of exposure passes

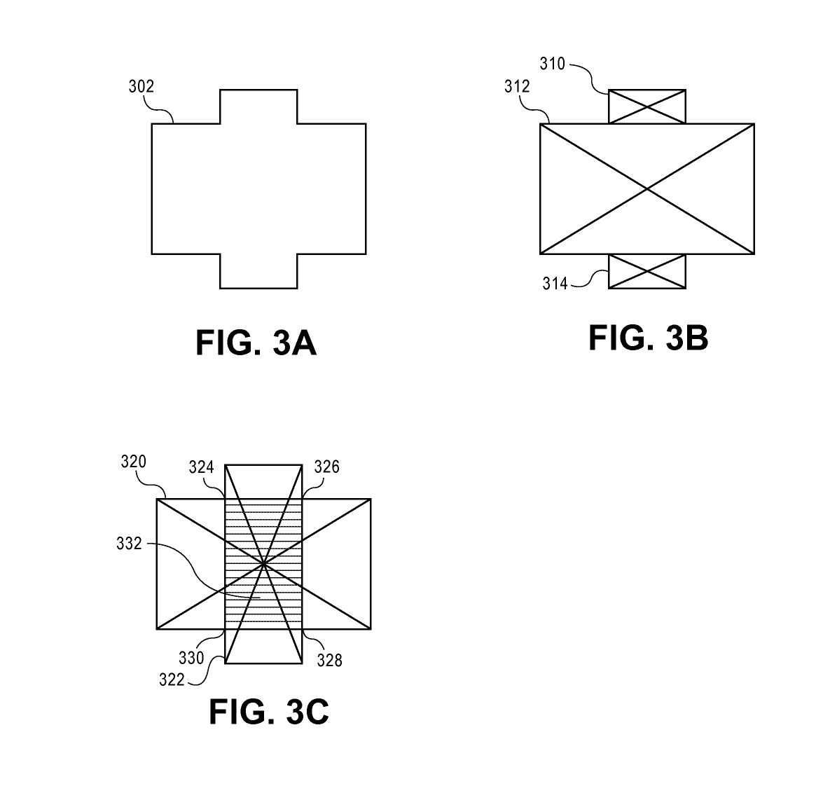

FIGS. 3A-C illustrate two known methods of fracturing a polygonal pattern. FIG. 3A illustrates a polygonal pattern 302 that is desired to be formed on a surface. FIG. 3B illustrates a conventional method of forming this pattern using non-overlapping or disjoint shots. Shot outline 310, shot outline 312 and shot outline 314 are mutually disjoint. Additionally, the three shots associated with these shot outlines all use a desired normal dosage, before proximity correction. An advantage of using the conventional method as shown in FIG. 3B is that the response of the resist can be easily predicted. Also, the shots of FIG. 3B can be exposed using a charged particle beam system which does not allow dosage assignment on a shot-by-shot basis, by setting the base dosage of the charged particle beam writer to the normal dosage. FIG. 3C illustrates an alternate method of forming the pattern 302 on a resist-coated surface using overlapping shots, disclosed in U.S. patent application Ser. No. 12/473,265, filed May 27, 2009 and entitled “Method And System For Design Of A Reticle To Be Manufactured Using Variable Shaped Beam Lithography.” In FIG. 3C the constraint that shot outlines cannot overlap has been eliminated, and shot 320 and shot 322 do overlap, where neither shot outline is a subset of the other shot outline. In the example of FIG. 3C, allowing shot outlines to overlap enables forming the pattern 302 in only two shots, compared to the three shots of FIG. 3B. In FIG. 3C, however the response of the resist to the overlapping shots is not as easily predicted as in FIG. 3B. In particular, the interior corners 324, 326, 328 and 330 may register as excessively rounded because of the large dosage received by overlapping region 332, shown by horizontal line shading. Charged particle beam simulation may be used to determine the pattern registered by the resist. In one embodiment, charged particle beam simulation may be used to calculate the dosage for each grid location in a two-dimensional (X and Y) grid, creating a grid of calculated dosages called a dosage map. The results of charged particle beam simulation may indicate use of non-normal dosages for shot 320 and shot 322. Additionally, in FIG. 3C the overlapping of shots in area 332 increases the area dosage beyond what it would be without shot overlap. While the overlap of two individual shots will not increase the area dosage significantly, this technique will increase area dosages and total dosage if used throughout a design.

In exposing, for example, a repeated pattern on a surface using charged particle beam lithography, the size of each pattern instance, as measured on the final manufactured surface, will be slightly different, due to manufacturing variations. The amount of the size variation is an essential manufacturing optimization criterion. In mask masking today, a root mean square (RMS) variation of no more than 1 nm (1 sigma) may be desired. More size variation translates to more variation in circuit performance, leading to higher design margins being required, making it increasingly difficult to design faster, lower-power integrated circuits. This variation is referred to as critical dimension (CD) variation. A low CD variation is desirable, and indicates that manufacturing variations will produce relatively small size variations on the final manufactured surface. In the smaller scale, the effects of a high CD variation may be observed as line edge roughness (LER). LER is caused by each part of a line edge being slightly differently manufactured, leading to some waviness in a line that is intended to have a straight edge. CD variation is inversely related to the slope of the dosage curve at the resist threshold, which is called edge slope. Therefore, edge slope, or dose margin, is a critical optimization factor for particle beam writing of surfaces.

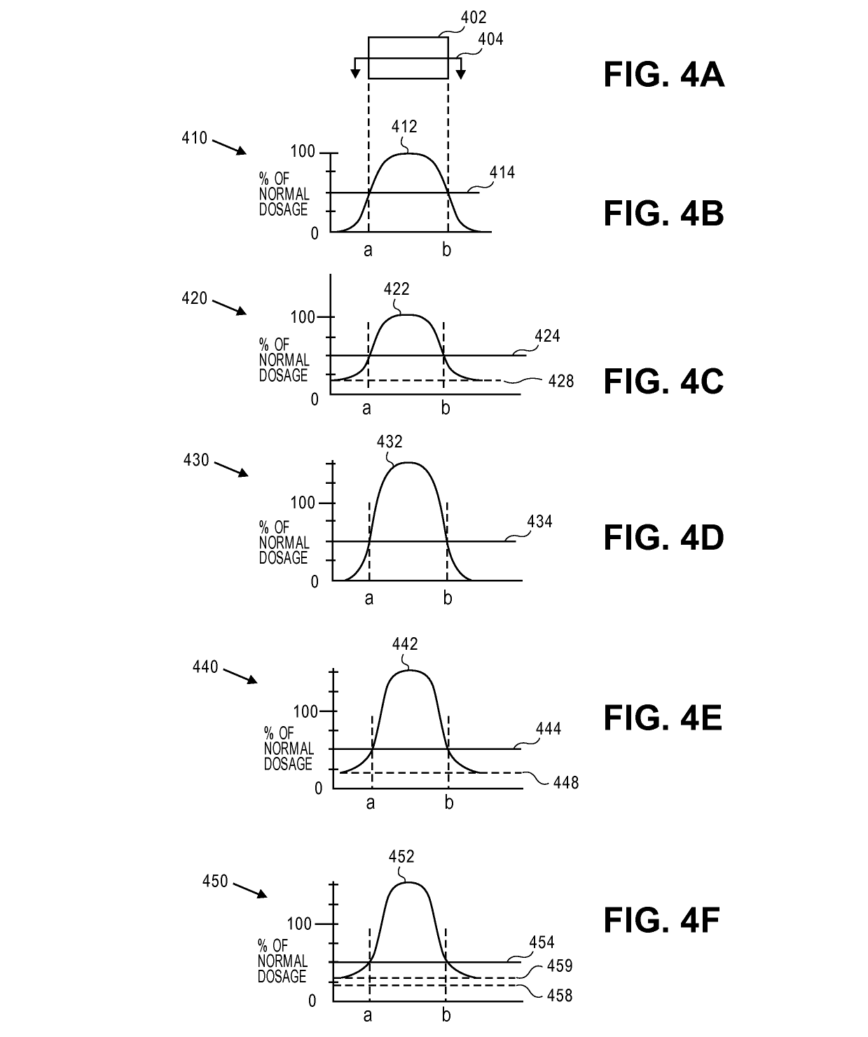

FIG. 4A illustrates an example of an outline of a rectangular shot 402. FIG. 4B illustrates an example of a dosage graph 410 illustrating the dosage along the line 404 through shot outline 402 with a normal shot dosage, with no back scatter, such as would occur if shot 402 was the only shot within the range of back scattering effect, which, as an example, may be 10 microns. Other long-range effects are also assumed to contribute nothing to the background exposure of FIG. 4B, leading to a zero background exposure level. The total dosage delivered to the resist is illustrated on the y-axis, and is 100% of a normal dosage. Because of the zero background exposure, the total dosage and the shot dosage are the same. Dosage graph 410 also illustrates the resist threshold 414. The CD variation of the shape represented by dosage graph 410 in the x-direction is inversely related to the slope of the dosage curve 412 at x-coordinates “a” and “b” where it intersects the resist threshold.

The FIG. 4B condition of zero background exposure is not reflective of actual designs. Actual designs will typically have many other shots within the backscattering distance of shot 402. FIG. 4C illustrates an example of a dosage graph 420 of a shot with a normal dosage with non-zero background exposure 428. In this example, a background exposure of 20% of a normal dosage is shown. In dosage graph 420, dosage curve 422 illustrates the cross-sectional dosage of a shot similar to shot 402. The CD variation of curve 422 is worse than the CD variation of curve 412, as indicated by the lower edge slope where curve 422 intersects resist threshold 424 at points “a” and “b”, due to the background exposure caused by back scatter.

One method of increasing the slope of the dosage curve at the resist threshold is to increase the shot dosage. FIG. 4D illustrates an example of a dosage graph 430 with a dosage curve 432 which illustrates a total dosage of 150% of normal dosage, with no background exposure. With no background exposure, the shot dosage equals the total dosage. Threshold 434 in FIG. 4D is unchanged from threshold 414 in FIG. 4B. Increasing shot dosage increases the size of a pattern registered by the resist. Therefore, to maintain the size of the resist pattern, illustrated as the intersection points of dosage curve 432 with threshold 434, the shot size used for dosage graph 430 is somewhat smaller than shot 402. As can be seen, the slope of dosage curve 432 is higher where it intersects threshold 434 than is the slope of dosage curve 412 where it intersects threshold 414, indicating a lower, improved, CD variation for the higher-dosage shot of FIG. 4D than for the normal dosage shot of FIG. 4B.

Like dosage graph 410, however, the zero background exposure condition of dosage graph 430 is not reflective of actual designs. FIG. 4E illustrates an example of a dosage graph 440 with the shot dosage adjusted to achieve a total dosage on the resist of 150% of normal dosage with a 20% background exposure, such as would occur if the dosage of only one shot was increased to 150% of a normal dosage, and dosage of other shots remained at 100% of normal dosage. The threshold 444 is the same as in FIGS. 4B-4D. The background exposure is illustrated as line 448. As can be seen, the slopes of dosage curve 442 at x-coordinates “a” and “b” are less than the slopes of dosage curve 432 at x-coordinates “a” and “b” because of the presence of backscatter. Comparing graphs 420 and 440 for the effect of shot dosage, the slope of dosage curve 442 at x-coordinates “a” and “b” is higher than the slope of dosage curve 422 at the same x-coordinates, indicating that improved edge slope can be obtained for a single shot by increasing dosage, if dosages of other shots remain the same.

FIG. 4F illustrates an example of a dosage graph 450, illustrating the case where the dosages of all shots have been increased to 150% of normal dose. Two background dosage levels are shown on dosage graph 450: a 30% background dose 459, such as may be produced if all shots use 150% of normal dosage, and a 20% background dose 458 shown for comparison, since 20% is the background dosage in the dosage graph 440. Dosage curve 452 is based on the 30% background dose 459. As can be seen, the edge slope of dosage curve 452 at x-coordinates “a” and “b” is less than that of dosage curve 442 at the same points.

In summary, FIGS. 4A-F illustrate that higher-than-normal dosage can be used selectively to lower CD variation for isolated shapes. Increasing dosage has two undesirable effects, however. First, an increase in dose is achieved in modern charged particle beam writers by lengthening exposure time. Thus, an increase in dose increases the writing time, which increases cost. Second, as illustrated in FIGS. 4E-F, if many shots within the back scatter range of each other use an increased dosage, the increase in back scatter reduces the edge slope of all shots, thereby worsening CD variation for all shots of a certain assigned dosage. The only way for any given shot to avert this problem is to increase dosage and shoot a smaller size. However, doing this increases the back scatter even more. This cycle causes all shots to be at a higher dose, making write times even worse. Therefore, it is better to increase dose only for shots that define the edge.

Edge slope or dose margin is an issue only at pattern edges. If, for example, the normal dosage is 2× the resist threshold, so as to provide a good edge slope, the interior areas of patterns can have a dosage lower than normal dosage, so long as dosage in all interior areas remains above the resist threshold, after accounting for some margin for manufacturing variation. In the present disclosure, two methods of reducing the dosage of interior areas of a pattern are disclosed:
If assigned shot dosages are available, use lower-than-normal shot dosages.
Insert gaps between shots in the interior of patterns. Although the shot outlines may show gaps, if the dosage within the gap area is everywhere above the resist threshold, with margin provided for manufacturing variation, no gap will be registered by the resist.
   Either or both of these techniques will reduce the area dosage, thus reducing the background dosage caused by back scatter. Edge slope at the pattern edges will therefore be increased, thereby improving CD variation.

Optimization techniques may be used to determine the lowest dosage that can be achieved in interior portions of the pattern. In some embodiments, these optimization techniques will include calculating the resist response to the set of shots, such as with using particle beam simulation, so as to determine that the set of shots forms the desired pattern, perhaps within a predetermined tolerance. Note that when creating shots for a charged particle beam writer which supports only unassigned dosage shots, gaps can be used in interior areas of the pattern to reduce area dosages and total dosage. By simulating, particularly with the “corner cases” of the manufacturing tolerance, designs with lower doses or gaps can be pre-determined to shoot the desired shapes safely with reduced write time and improved edge slope.

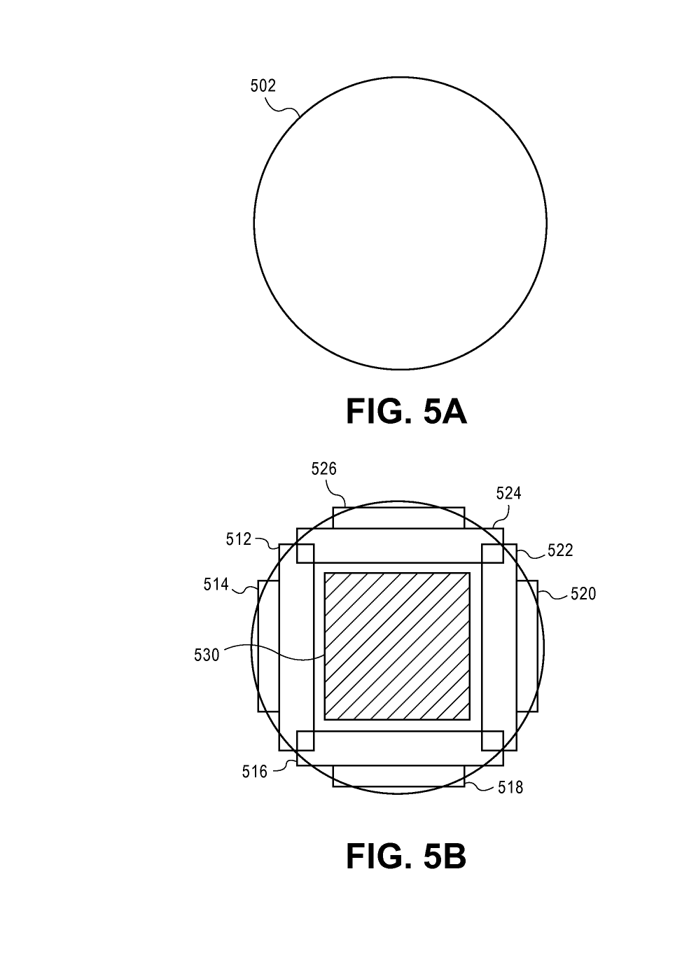

FIG. 5A illustrates an example of a circular pattern 502 that is to be formed on a surface. FIG. 5B illustrates an example of how the pattern 502 may be formed with a set of nine VSB shots with assigned shot dosages. FIG. 5B illustrates the shot outlines of each of the nine shots. In FIG. 5B, overlapping shots 512, 514, 516, 518, 520, 522, 524 and 526 may be assigned a relatively higher set of dosages, or perhaps all assigned a normal dosage, to maintain a good edge slope, since each of these shots defines the perimeter of the pattern on the surface. Shot 530, however, may have an assigned dosage less than shots 512, 514, 516, 518, 520, 522, 524 and 526, such as 0.7× a normal dosage, since shot 530 does not define an edge of the pattern. The shot sizes will be carefully chosen so as not to have any portion of the interior of shape 502 fall below the resist threshold, perhaps with some margin for manufacturing variation. Shot 530 may also be sized so that a gap exists between the outline of shot 530 and the outline of each of the adjacent shots, as illustrated in FIG. 5B. When a gap is present, the union of outlines of shots in the set of shots does not cover the desired pattern. Particle beam simulation may be used to determine an optimal size for the gap so that dosage may be reduced without causing a gap to be registered by the resist. The use of lower-than-normal dosage for shot 530, when applied to a large number of such shots within the back scatter range of each other, will reduce the back scatter and fogging, contributing to improved edge slope, compared to exposing shot 530 with a normal dosage.

The solution described above with FIG. 5B may be implemented even using a charged particle beam system that does not allow dosage assignment for individual shots. In one embodiment of the present invention, a small number of dosages may be selected, for example two dosages such as 1.0× normal and 0.7× normal, and shots for each of these two dosages may be separated and exposed in two separate exposures passes, where the base dosage for one exposure pass is 1.0× normal and the base dosage for the other exposure pass is 0.7× normal. In the example of FIG. 5B, shots 512, 514, 516, 518, 520, 522, 524 and 526 may be assigned to a first exposure pass which uses a base dosage of 1.0× normal dosage before PEC correction. Shot 530 may be assigned to a second exposure pass which uses a base dosage of 0.7× normal dosage before PEC correction.

Overlapping shots may be used to create resist dosages greater than 100% of normal, even with charged particle beam writers which do not support dosage assignment for individual shots. In FIG. 5B, for example outlines for shots 514 and 512, shots 526 and 524 shots 520 and 522, and shots 518 and 516 may be designed to overlap, creating regions of higher-than-normal dosage in the periphery. The higher energy that is cast from these regions can “fill in” the gap between shot outline 530 and the peripheral shots, making it possible to decrease the size of shot 530.

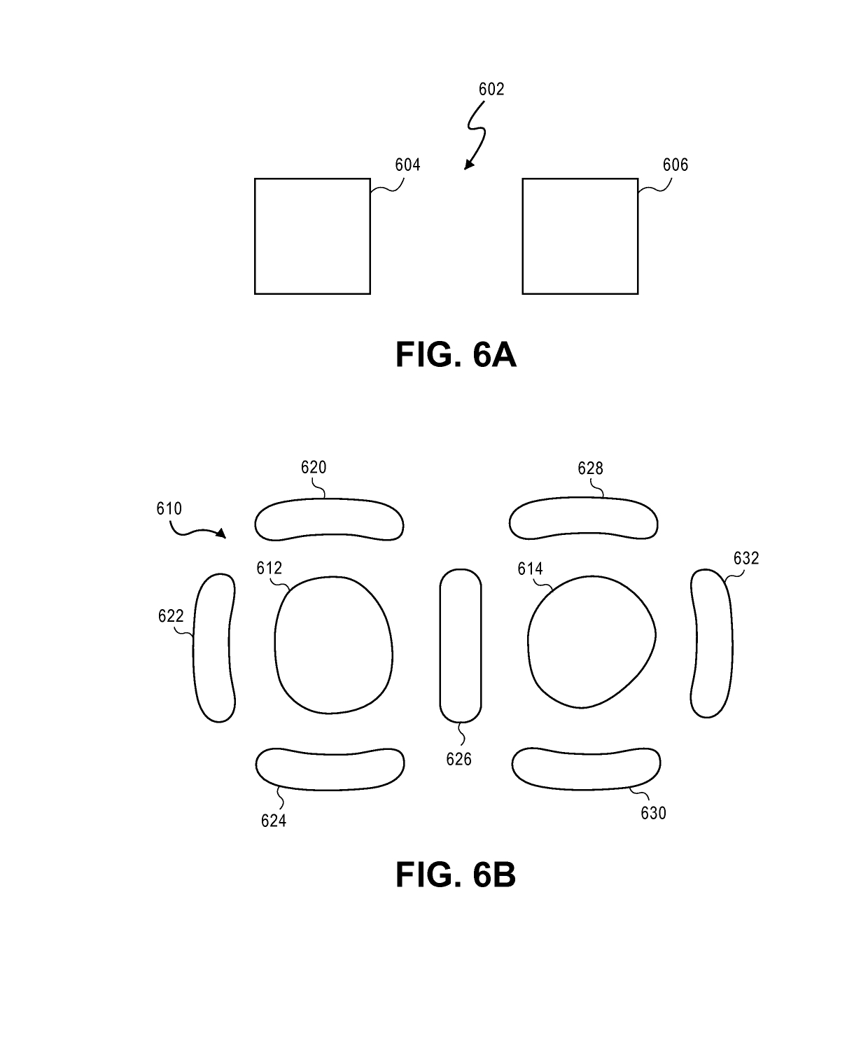

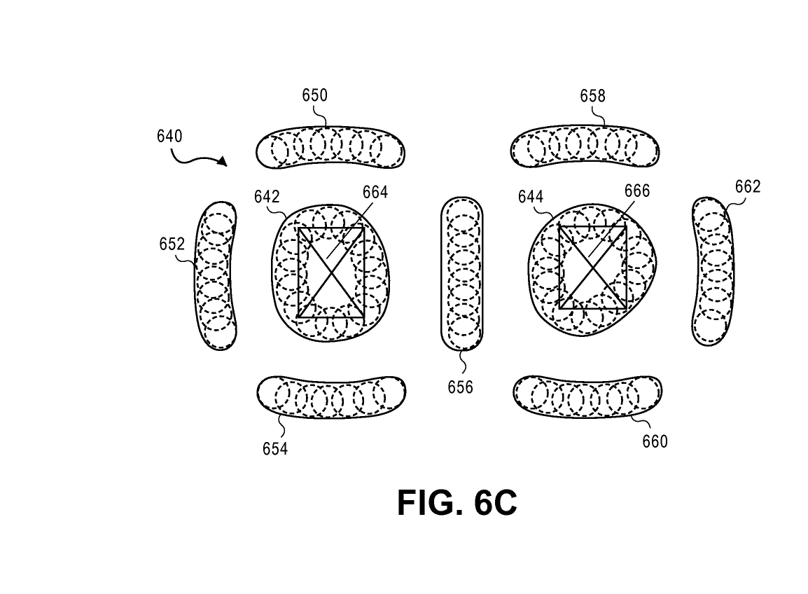

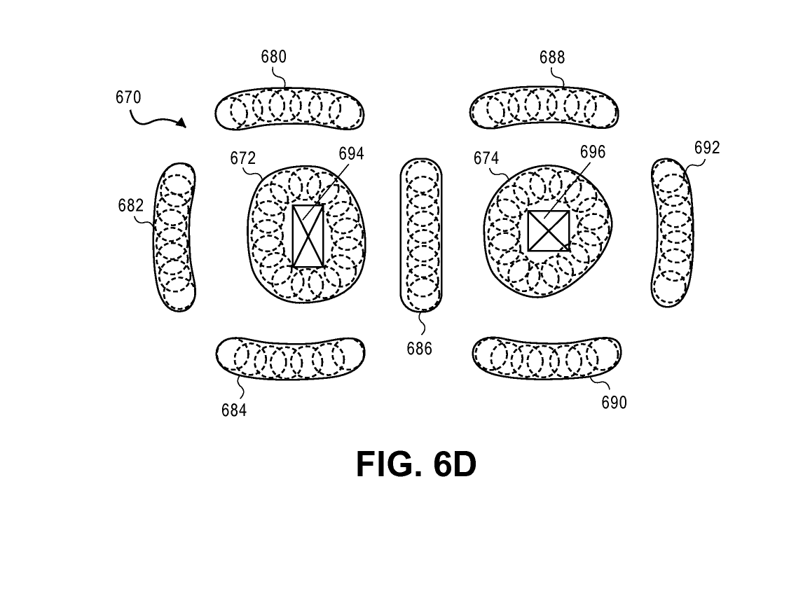

FIG. 6A illustrates a pattern comprising two squares 604 and 606, such as may occur on contact or via layers of an integrated circuit design. FIG. 6B illustrates a curvilinear pattern 610 that may result from advanced OPC processing of the pattern of FIG. 6A. Pattern 610 is a desired pattern to be formed on a reticle, where the reticle will be used in an optical lithographic process to produce a pattern similar to 604 and 606 on a substrate. Pattern 610 is comprised of two main shapes: shape 612 and shape 614, and seven SRAF shapes: shape 620, shape 622, shape 624, shape 626, shape 628, shape 630 and shape 632. FIG. 6C illustrates an example 640 of how dragged shots can be used to form most of FIG. 6B pattern 610. Dragged shots are disclosed in U.S. patent application Ser. No. 12/898,646, filed Oct. 5, 2010 and entitled “Method and System For Manufacturing a Surface Using Charged Particle Beam Lithography,” which is hereby incorporated by reference. The plurality of dashed line circles in pattern 650, for example, denotes a single dragged shot of a circular CP character. Shot group 640 comprises dragged shots 642, 644, 650 652, 654, 656, 658, 660 and 662, plus VSB shots 664 and 666. In FIG. 6C the VSB shots 664 and 666 have embedded “X” patterns to aid the illustration. The VSB shot outlines 664 and 666 overlap the outlines of the dragged shots which define the perimeters of patterns 642 and 644. In one embodiment of this disclosure, when a charged particle beam writer with individual shot dosage assignment is used, shot 664 and shot 666 may be assigned a less than normal dosage. FIG. 6D illustrates another example of how a plurality of dragged shots and two VSB shots may be used to form the pattern of FIG. 6B, in another embodiment of this disclosure. The dragged shots of FIG. 6D shot group 670 are the same as in shot group 640. The VSB shots 694 and 696 of FIG. 6D, however, are smaller than VSB shots 664 and 666 of FIG. 6C. As can be seen from FIG. 6D, gaps exist between the VSB shot outlines and the outline of the dragged shots. The response of the resist, when calculated using, for example, particle beam simulation, may indicate that the dosage in all areas of the gaps is above the threshold of the resist, in which case the smaller VSB shots of shot group 670 are preferred over the VSB shots of shot group 640, because they reduce the area dosage in the area of this pair of contacts or vias.

In one embodiment of the invention, gaps between normal-dosage or near-normal-dosage shots may be filled or partially filled with low-dosage shots, such as shots having less than 50% of normal dosage.

The dosage that would be received by a surface can be calculated and stored as a two-dimensional (X and Y) dosage map called a glyph. A two-dimensional dosage map or glyph is a two-dimensional grid of calculated dosage values for the vicinity of the shots comprising the glyph. This dosage map or glyph can be stored in a library of glyphs. The glyph library can be used as input during fracturing of the patterns in a design. For example, referring again to FIGS. 5A&B, a dosage map may be calculated for the combination of shots 512, 514, 516, 518, 520, 522, 524, 526 and 530 and stored in the glyph library. If during fracturing, one of the input patterns is a circle of the same size as circular pattern 502, the glyph for circular pattern 502 and the nine shots comprising the glyph may be retrieved from the library, avoiding the computational effort of determining an appropriate set of shots to form the circular input pattern. Glyphs may also contain CP shots, and may contain dragged CP or VSB shots. A series of glyphs may also be combined to create a parameterized glyph. Parameters may be discrete or may be continuous. For example, the shots and dosage maps for forming circular patterns such as circular pattern 502 may be calculated for a plurality of pattern diameters, and the plurality of resulting glyphs may be combined to form a discrete parameterized glyph. In another example, a pattern width may be parameterized as a function of dragged shot velocity.

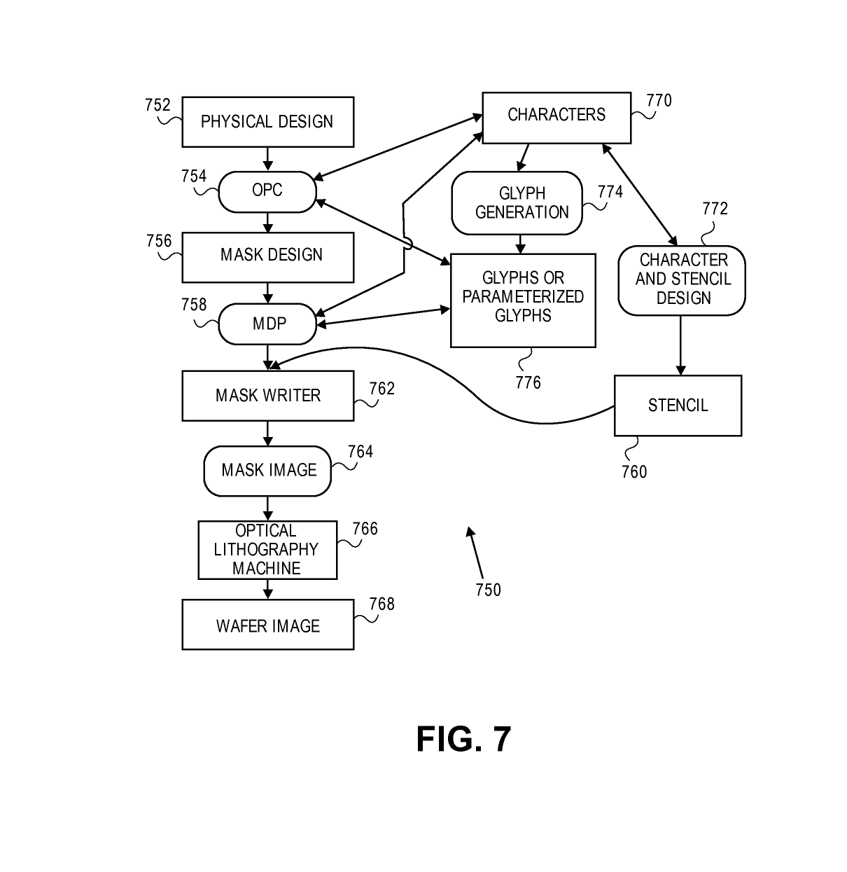

FIG. 7 is a conceptual flow diagram 750 of how to prepare a reticle for use in fabricating a surface such as an integrated circuit on a silicon wafer. In a first step 752, a physical design, such as a physical design of an integrated circuit, is designed. This can include determining the logic gates, transistors, metal layers, and other items that are required to be found in a physical design such as that in an integrated circuit. Next, in a step 754, optical proximity correction is determined. In an embodiment of this disclosure this can include taking as input a library of pre-calculated glyphs or parameterized glyphs 776. This can also alternatively, or in addition, include taking as input a library of pre-designed characters 770 including complex characters that are to be available on a stencil 760 in a step 762. In an embodiment of this disclosure, an OPC step 754 may also include simultaneous optimization of shot count or write times, and may also include a fracturing operation, a shot placement operation, a dose assignment operation, or may also include a shot sequence optimization operation, or other mask data preparation operations, with some or all of these operations being simultaneous or combined in a single step. Once optical proximity correction is completed a mask design is developed in a step 756.

In a step 758, a mask data preparation operation which may include a fracturing operation, a shot placement operation, a dose assignment operation, or a shot sequence optimization may take place. Either of the steps of the OPC step 754 or of the MDP step 758, or a separate program independent of these two steps 754 or 758 can include a program for determining a limited number of stencil characters that need to be present on a stencil or a large number of glyphs or parameterized glyphs that can be shot on the surface with a small number of shots by combining characters that need to be present on a stencil with varying dose, position, and degree of partial exposure to write all or a large part of the required patterns on a reticle. Combining OPC and any or all of the various operations of mask data preparation in one step is contemplated in this disclosure. Mask data preparation step 758 which may include a fracturing operation may also comprise a pattern matching operation to match glyphs to create a mask that matches closely to the mask design. In some embodiments of this disclosure, mask data preparation step 758 may include varying shot dosages to produce a higher peak dosage near perimeters of generated patterns than in the interior of the generated patterns. In other embodiments, generated shots may have gaps between the shot outlines of nearest neighboring shots, so that area dosage is decreased, but where the gaps will not be registered by the resist in the subsequently-produced mask image 764. In another embodiment, step 758 may include optimization by changing the size of the gaps. Mask data preparation may also comprise inputting patterns to be formed on a surface with the patterns being slightly different, selecting a set of characters to be used to form the number of patterns, the set of characters fitting on a stencil mask, the set of characters possibly including both complex and VSB characters, and the set of characters based on varying character dose or varying character position or applying partial exposure of a character within the set of characters or dragging a character to reduce the shot count or total write time. A set of slightly different patterns on the surface may be designed to produce substantially the same pattern on a substrate. Also, the set of characters may be selected from a predetermined set of characters. In one embodiment of this disclosure, a set of characters available on a stencil in a step 770 that may be selected quickly during the mask writing step 762 may be prepared for a specific mask design. In that embodiment, once the mask data preparation step 758 is completed, a stencil is prepared in a step 760. In another embodiment of this disclosure, a stencil is prepared in the step 760 prior to or simultaneous with the MDP step 758 and may be independent of the particular mask design. In this embodiment, the characters available in the step 770 and the stencil layout are designed in step 772 to output generically for many potential mask designs 756 to incorporate slightly different patterns that are likely to be output by a particular OPC program 754 or a particular MDP program 758 or particular types of designs that characterizes the physical design 752 such as memories, flash memories, system on chip designs, or particular process technology being designed to in physical design 752, or a particular cell library used in physical design 752, or any other common characteristics that may form different sets of slightly different patterns in mask design 756. The stencil can include a set of characters, such as a limited number of characters that was determined in the step 758, including a set of adjustment characters.

Once the stencil is completed the stencil is used to generate a surface in a mask writer machine, such as an electron beam writer system. This particular step is identified as a step 762. The electron beam writer system projects a beam of electrons through the stencil onto a surface to form patterns in a surface, as shown in a step 764. The completed surface may then be used in an optical lithography machine, which is shown in a step 766. Finally, in a step 768, a substrate such as a silicon wafer is produced. As has been previously described, in step 770 characters may be provided to the OPC step 754 or the MDP step 758. The step 770 also provides characters to a character and stencil design step 772 or a glyph generation step 774. The character and stencil design step 772 provides input to the stencil step 760 and to the characters step 770. The glyph generation step 774 provides information to a glyphs or parameterized glyphs step 776. Also, as has been discussed, the glyphs or parameterized glyphs step 776 provides information to the OPC step 754 or the MDP step 758.

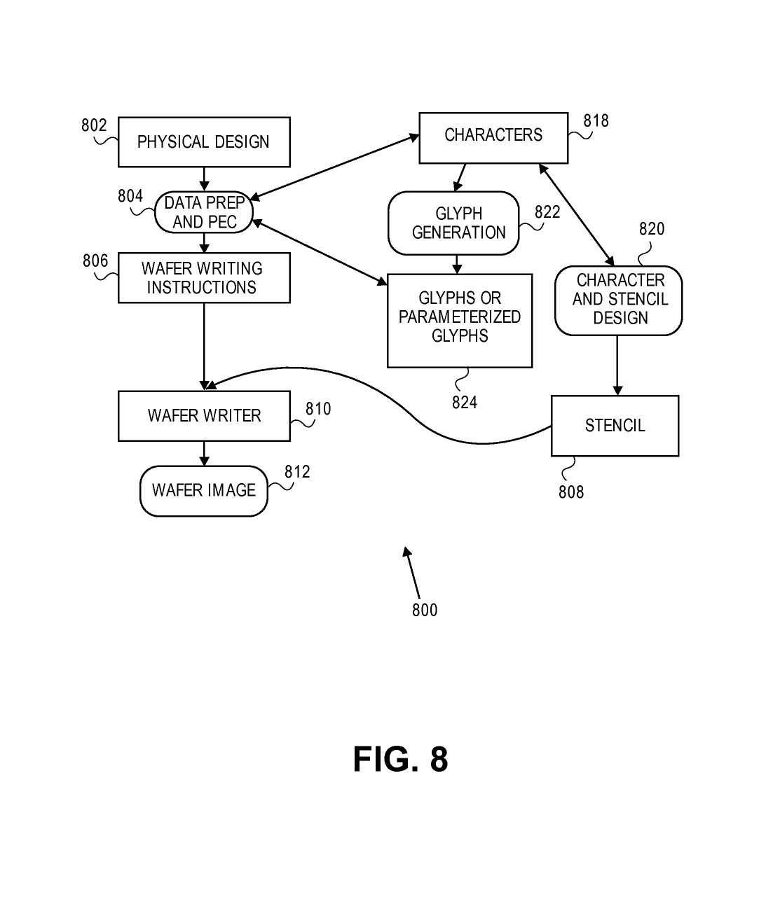

Referring now to FIG. 8, another exemplary conceptual flow diagram 800 of how to prepare a surface which is directly written on a substrate such as a silicon wafer is shown. In a first step 802, a physical design, such as a physical design of an integrated circuit is designed. This may be an ideal pattern that the designer wants transferred onto a substrate. Next, in a step 804, various data preparation (DP) steps, including fracturing and PEC, are performed to prepare input data to a substrate writing device. Step 804 may include fracturing of the patterns into a set of complex CP and/or VSB shots, where some of the shots may overlap each other. The step 804 may also comprise inputting possible glyphs or parameterized glyphs from step 824, the glyphs being based on predetermined characters from step 818, and the glyphs being determined using a calculation of varying a character dose or varying a character position or applying partial exposure of a character in glyph generation step 822. The step 804 may also comprise pattern matching to match glyphs to create a wafer image that matches closely to the physical design created in the step 802. Iterations, potentially including only one iteration where a correct-by-construction “deterministic” calculation is performed, of pattern matching, dose assignment, and equivalence checking may also be performed. In some embodiments of this disclosure, data preparation step 804 may include varying shot dosages to produce a higher peak dosage near perimeters of the generated patterns than in the interior of the generated patterns. In other embodiments, generated shots may have gaps between the shot outlines of nearest neighboring shots, so that area dosage is decreased, but where the gaps will not be registered by the resist in the subsequently-produced wafer image 812. In another embodiment, step 804 may include optimization by changing the size of the gaps. A stencil is prepared in a step 808 and is then provided to a wafer writer in a step 810. Once the stencil is completed the stencil is used to prepare a wafer in a wafer writer machine, such as an electron beam writer system. This step is identified as the step 810. The electron beam writer system projects a beam of electrons through the stencil onto a surface to form patterns in a surface. The surface is completed in a step 812.

Further, in a step 818 characters may be provided to the data preparation and PEC step 804. The step 818 also provides characters to a glyph generation step 822. The character and stencil design step 820 provides input to the stencil step 808 or to a character step 818. The character step 818 may provide input to the character and stencil design step 820. The glyph generation step 822 provides information to a glyphs or parameterized glyphs step 824. The glyphs or parameterized glyphs step 824 provides information to the Data Prep and PEC step 804. The step 810 may include repeated application as required for each layer of processing, potentially with some processed using the methods described in association with FIG. 7, and others processed using the methods outlined above with respect to FIG. 8, or others produced using any other wafer writing method to produce integrated circuits on the silicon wafer.

The fracturing, mask data preparation, proximity effect correction and glyph creation flows described in this disclosure may be implemented using general-purpose computers with appropriate computer software as computation devices. Due to the large amount of calculations required, multiple computers or processor cores may also be used in parallel. In one embodiment, the computations may be subdivided into a plurality of 2-dimensional geometric regions for one or more computation-intensive steps in the flow, to support parallel processing. In another embodiment, a special-purpose hardware device, either used singly or in multiples, may be used to perform the computations of one or more steps with greater speed than using general-purpose computers or processor cores. In one embodiment, the special-purpose hardware device may be a graphics processing unit (GPU). In another embodiment, the optimization and simulation processes described in this disclosure may include iterative processes of revising and recalculating possible solutions, so as to minimize either the total number of shots, or the total charged particle beam writing time, or some other parameter. In yet another embodiment, an initial set of shots may be determined in a correct-by-construction method, so that no shot modifications are required.

While the specification has been described in detail with respect to specific embodiments, it will be appreciated that those skilled in the art, upon attaining an understanding of the foregoing, may readily conceive of alterations to, variations of, and equivalents to these embodiments. These and other modifications and variations to the present methods for fracturing, mask data preparation, and proximity effect correction may be practiced by those of ordinary skill in the art, without departing from the spirit and scope of the present subject matter, which is more particularly set forth in the appended claims. Furthermore, those of ordinary skill in the art will appreciate that the foregoing description is by way of example only, and is not intended to be limiting. Steps can be added to, taken from or modified from the steps in this specification without deviating from the scope of the invention. In general, any flowcharts presented are only intended to indicate one possible sequence of basic operations to achieve a function, and many variations are possible. Thus, it is intended that the present subject matter covers such modifications and variations as come within the scope of the appended claims and their equivalents.

1. A method for fracturing or mask data preparation comprising the steps of:
inputting a desired pattern to be formed on a surface; and
determining a set of charged particle beam shots which will form the desired pattern on the surface;
wherein a shot in the set of shots is a dragged shot, and wherein the set of shots will produce a higher peak dosage near the perimeter of the desired pattern than in the interior area of the desired pattern.

2. The method of claim 1 wherein the dragged shot is used to form a portion of the perimeter of the pattern.

3. A method for fracturing or mask data preparation comprising the steps of:
inputting a desired pattern to be formed on a surface; and
determining a set of charged particle beam shots which will form the desired pattern on the surface;
wherein at least two shots overlap, neither shot being a subset of the other, and wherein the set of shots will produce a higher peak dosage near the perimeter of the desired pattern than in the interior area of the desired pattern.

4. The method of claim 3 wherein the union of shots in the set of shots does not fully cover the desired pattern.

5. The method of claim 4 wherein the step of determining comprises determining locations of the shots so that gaps exist between nearest-neighboring shots.

6. The method of claim 5 wherein the step of determining further comprises using an optimization technique, wherein the gaps are changed in size.

7. The method of claim 3 wherein the step of determining comprises calculating the pattern that will be formed on the surface by the set of charged particle beam shots.

8. The method of claim 7 wherein the calculating comprises charged particle beam simulation.

9. The method of claim 8 wherein the charged particle beam simulation includes at least one of a group consisting of forward scattering, backward scattering, resist diffusion, Coulomb effect, etching, fogging, loading and resist charging.

10. The method of claim 3 wherein the set of shots comprises at least one shot of a complex character.

11. The method of claim 3 wherein the set of shots comprises a plurality of subsets of shots, and wherein each subset of shots is designated for exposure in a different exposure pass.

12. The method of claim 3 wherein the step of determining uses an optimization technique.

13. The method of claim 12 wherein the set of shots comprises a total dosage, and wherein the optimization technique reduces the total dosage.

14. A system for fracturing or mask data preparation comprising:
a device capable of inputting a desired pattern to be formed on a surface; and
a device capable of determining a set of shots which will form the desired pattern, wherein a shot in the subset of shots is a dragged shot, and wherein the set of shots will produce a higher peak dosage near the perimeter of the desired pattern than in the interior area of the desired pattern.

15. The system of claim 14 wherein the dragged shot will form at least a portion of the perimeter of the desired pattern.

16. A system for fracturing or mask data preparation comprising:
a device capable of inputting a desired pattern to be formed on a surface; and
a device capable of determining a set of shots which will form the desired pattern, wherein at least two shots overlap, neither shot being a subset of the other, and wherein the set of shots will produce a higher peak dosage near the perimeter of the desired pattern than in the interior area of the desired pattern.

17. The system of claim 16 wherein the union of shots in the set of shots does not fully cover the desired pattern.

18. The system of claim 17 wherein the device capable of determining creates gaps between nearest-neighboring shots.

19. The system of claim 16 wherein the device capable of determining uses an optimization technique.

20. The system of claim 19 wherein the set of shots comprises a total dosage, and wherein the total dosage is reduced.

21. The system of claim 16 wherein the device capable of determining calculates the pattern that will be formed on the surface from the set of shots.

22. The system of claim 21 wherein the calculation comprises charged particle beam simulation.

23. The system of claim 22 wherein the charged particle beam simulation includes at least one of a group consisting of forward scattering, backward scattering, resist diffusion, coulomb effect, etching, fogging, loading and resist charging.

24. The system of claim 16 wherein the set of shots comprises at least one complex character.

25. The system of claim 16 wherein the set of shots comprises a plurality of subsets of shots, and wherein each subset of shots is designated for exposure in a different exposure pass.
